(19) United States
(12) Patent Application Publication
(10) Pub. No.: US 2008/0233353 A1
(43) Pub. Date: Sep. 25, 2008

(54) RECESS FORMATION METHOD, RECESS FORMATION DEVICE, AND FORMATION MATERIAL FOR RECESS

(76) Inventor: Junya Sakurai, Tokyo (JP)

Correspondence Address: NEC CORPORATION OF AMERICA, 6535 N. STATE HWY 161, IRVING, TX, 75039, US

(21) Appl. No.: 12/051,582

(22) Filed: Mar. 19, 2008

(30) Foreign Application Priority Data
Mar. 22, 2007 (JP) 2007-074432

(51) Int. Cl. B32B 3/00; B32B 38/10; B26D 3/00

(52) U.S. Cl. 428/156; 156/248; 83/337

(57) ABSTRACT

In the present invention, a sheet is disposed inside a material that is the target for forming a recess, the sheet having a first physical property that is different from a physical property of the material and having a planar shape identical to the planar shape of a recess to be formed. Then, the material is cut in a depth direction from a first surface of the material using a cutting tool. At this time, a physical property of a deepest part of the cut portion is detected using a detector, and cutting in the depth direction is terminated when the property is equal to the first physical property. The material is cut also in a horizontal direction that is substantially parallel to the first surface to form a groove, thereby dividing the first surface into a first region having a shape identical to the planar shape, and a into second region that is the other region. Lastly, the material between the sheet and the first surface in the first region is peeled off.

This application is based upon and claims the benefit of priority from Japanese Patent Application No. 2007-074432 filed on Mar. 22, 2007, the content of which is incorporated by reference.

### BACKGROUND OF THE INVENTION

1. Field of the Invention

The present invention relates to a method for forming a recess, and specifically relates to a recess formation method using a release sheet. Also, the present invention relates to a recess formation device and a formation material for recess.

2. Description of the Related Art

Conventionally, the processing for forming a recess (hereinafter referred to as “recess formation processing”) has been performed on materials used in various devices. This recess formation processing is also referred to as “counterboring”.

For example, a printed wiring board used in an electronic device may be subjected to recess formation processing. With the enhancement of the functions of electronic devices, printed wiring boards used in devices are becoming highly multilayered and the thicknesses of these printed wiring boards increases. A bookshelf-type housing may be used for an electronic device that includes many printed wiring boards. The “bookshelf-type” housing is a housing that holds boards such as printed wiring boards in such a manner that books are held in a “bookshelf”. In examples of this housing, there is a housing which includes a package having a plurality of shelves for holding boards which is capable of holding the boards arranged in parallel in the shelves. Such bookshelf-type housing is provided with guide rails for supporting the printed wiring boards. When inserting a printed wiring board whose board thickness exceeds the width of a guide rail, it is necessary to cut the edge of the printed wiring board down to be thinner.

Also, for printed wiring boards for semiconductor packages, the recess formation processing for forming a recess called a cavity in which a chip is to be embedded, has been required for enhancing heat release, etc.

As stated above, in recent years, the demand for performing recess formation processing on various materials such as a printed wiring board, has been increasing, but recess formation processing has the disadvantage of requiring a relatively long time and high manufacturing costs.

FIG. 1 is a perspective view indicating a conventional recess formation method. As shown in the Figure, there is a cutting method in which cutting tools (end mills) 1201 and 1202 each having a helical cutting blade, are moved while being rotated, thereby reducing edge 1204 of material 1203 and also forming recess 1205 in a predetermined shape such as a fan-shape. This kind of cutting method is referred to as “routing”.

Alternatively, there is a method in which a cavity is formed in a substrate using a release sheet. In this method, a release sheet having a planar identical to the planar shape of the cavity, is embedded in a substrate by forming or depositing the release sheet on an inner layer of the substrate. Next, a groove whose depth is from the substrate surface to the position of the release sheet, is formed along the outer periphery of the release sheet using a cutting tool. Then, lastly, the upper layer of the substrate is peeled off together with the release sheet, thereby a recess is formed. Examples of this method are disclosed in Japanese Patent Laid-Open No. 10-22645 (pages 2 and 3, FIGS. 1 and 3) and Japanese Patent Laid-Open No. 2001-358247 (pages 4 and 5, and FIGS. 1 to 3).

In the methods disclosed in Japanese Patent Laid-Open No. 10-22645 and Japanese Patent Laid-Open No. 2001-358247, the material in a portion where a recess is to be formed, is removed using a release sheet, so the processing time can be reduced. More specifically, since the area of the portion for forming a recess is larger, the time reduction effect become higher. As a result of the processing-time reduction, the effect of manufacturing-cost reduction can also be obtained. Furthermore, since a recess can be evenly formed at the depth of the position where the release sheet is embedded, processing accuracy in the depth direction is high. In particular, a high effect can be obtained when exposing the inner layer.

However, the recess formation processing method related to the present invention, has the following problems. First, in the method shown in FIG. 1, processing for forming recesses in the printed wiring board using cutting tools 1201 and 1202 is performed by removing the material in all the portions where the recesses are to be formed, by means of cutting. Accordingly, it is necessary to perform cutting in stages that uses cutting tools 1201 and 1202, such as router bits (small end mills), and that requires a relatively long time for processing. There is also a problem in that a variation may occur in the processing accuracy in the depth direction of the recesses due to the influence of warpage occurring in the printed wiring board.

In the methods disclosed in Japanese Patent Laid-Open Nos. 10-22645 and 2001-358247, it is necessary to exactly match the depth of a groove formed with the depth of the position of the release sheet, thus controlling the position of a cutting tool in the depth direction is difficult. This will be more difficult when the release sheet is thin. Also, when the depth of the position where the release sheet is embedded, is not constant because of insufficient accuracy, etc., a groove deeper than the position of the release sheet may be formed.

### SUMMARY OF THE INVENTION

The present invention has been made in view of the aforementioned technical problems, and an object of the present invention is to provide a recess formation method, a recess formation device, and a formation material for recess, which are capable of forming a recess having a highly-accurate depth in a relatively short amount of processing time.

In order to achieve the above object, a recess processing method according to the present invention comprises: forming a material with a sheet disposed therein, the sheet having a planar shape identical to a planar shape of a recess to be formed and having a first physical property, the material having a second physical property that is different from the first physical property; cutting the material in a depth direction that is a direction going from a first surface of the material toward a second surface of the material facing the first surface, using a predetermined cutting tool; detecting a third physical property that is a physical property of the deepest part of the cut portion, using a predetermined detector; terminating the cutting in the depth direction when the third physical property is equal to the first physical property; cutting the material in a horizontal direction that is substantially parallel to the first surface to form a groove, thereby dividing the first surface into a first region having a shape identical to the planar shape, and into a second region that is the other region; and peeling off the material between the sheet and the first surface in the first region.

Furthermore, the material may include a plurality of layers, the plurality of layers including a first layer and a second layer positioned below the first layer viewed from the first surface, and the sheet may be embedded between the first layer and the second layer; and the method may further comprise peeling off the material, that is above the second layer viewed from the first surface in the first region, from the sheet.

A recess formation device for forming a recess in a material comprises: a cutter that cuts a material with a sheet disposed therein in a depth direction that is a direction going from a first surface of the material toward a second surface of the material facing the first surface, the sheet having a planar shape identical to a planar shape of a recess to be formed and having a first physical property, the material having a second physical property that is different from the first physical property; a detector that detects a third physical property that is a physical property of the deepest part of the cut portion; a controller that terminates the cutting in the depth direction when the third physical property is equal to the first physical property, and cuts the material in a horizontal direction that is substantially parallel to the first surface to form a groove, thereby dividing the first surface into a first region having a shape identical to the planar shape, and into a second region that is the other region; and a peeler that peels off the material between the sheet and the first surface in the first region.

The material may include a plurality of layers, the plurality of layers including a first layer and a second layer positioned below the first layer viewed from the first surface, and the sheet may be embedded between the first layer and the second layer; and the peeler may peel off the material above the second layer viewed from the first surface in the first region, from the sheet.

Also, a formation material for recess comprises: a sheet having a planar shape identical to a planar shape of a recess to be formed and having a first physical property; and a second physical property that is different from the first physical property, wherein the recess being formed includes: cutting the material in a depth direction that is a direction going from a first surface toward a second surface facing the first surface, using a predetermined cutting tool; detecting a third physical property that is a physical property of the deepest part of the cut portion, using a predetermined detector; terminating cutting in the depth direction when the third physical property is equal to the first physical property; cutting the material in a horizontal direction that is substantially parallel to the first surface to form a groove, thereby dividing the first surface into a first region having a shape identical to the planar shape, and into a second region that is the other region; and peeling off the portion between the sheet and the first surface in the first region.

At this time, the formation material for a recess, may include a plurality of layers, the plurality of layers including a first layer and a second layer positioned below the first layer viewed from the first surface, and the sheet may be embedded in the first layer and the second layer; and the recess may be formed by peeling off the formation material for a recess in the first region from the sheet.

Each of the above physical property may be an electric conductivity of the material or may also be an elastic modulus of the material. The sheet may include a surface coated with a coating material having the first physical property.

In the recess formation method according to the present invention, a recess is formed by peeling off a portion where a recess is to be formed using a sheet embedded in a material and a groove formed along a shape identical to the outer shape of the sheet. At that time, the depth of the groove is controlled by detecting the physical property of the bottom of the groove.

Accordingly, the recess formation method according to the present invention makes it possible to easily form a groove having a depth equal to the depth of the position of the sheet disposed inside the material. Also, the recess formation method according to the present invention makes it possible to accurately form a groove having the same depth as the depth of the position of the sheet even when the sheet is thin, or even when the depth at which the sheet is embedded is not constant.

Consequently, the recess formation method according to the present invention has the advantage of forming a recess having a highly-accurate depth in a relatively short amount of processing time.

### BRIEF DESCRIPTION OF THE DRAWINGS

FIG. 1 is a perspective view indicating a recess formation method related to the present invention;

FIG. 2A is a side view indicating an exemplary embodiment;

FIG. 2B is a side view indicating an exemplary embodiment;

FIG. 3 is a perspective view of release sheets used in an exemplary embodiment;

FIG. 4 is a perspective view of a printed wiring board core material to which release sheets are attached;

FIG. 5 is a perspective view indicating a laminated state of a core material to which release sheets are attached and other layers;

FIG. 6 is a perspective view of a multi-layer printed wiring board including a layer to which release sheets are attached;

FIG. 7A is a plain view of a printed wiring board in which grooves have been formed using cutting tools;

FIG. 7B is a side view of a printed wiring board in which grooves have been formed using cutting tools;

FIG. 8 is a perspective view indicating a groove formation method using V-cutting and routing;

FIG. 9 is a perspective view indicating a printed wiring board from which portions where recesses are to be formed have been removed;

FIG. 10A is a side view indicating a recess formation method according to a first example;

FIG. 10B is a side view indicating a recess formation method according to the first example;

FIG. 10C is a side view indicating a recess formation method according to the first example;

FIG. 11A is a perspective view of a material in which a recess has been formed in a second example;

FIG. 11B is a perspective view indicating a release sheet for forming a recess in the second example; and

FIG. 12 is a block diagram illustrating a configuration of a recess formation device according to a third example.

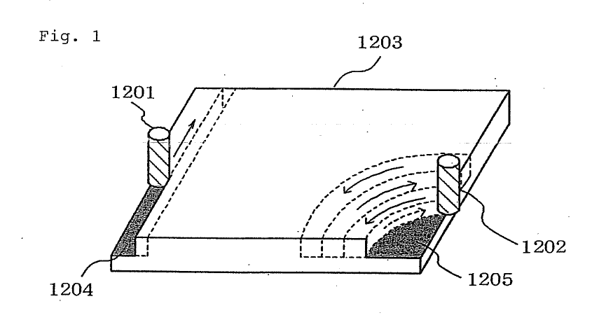

### DETAILED DESCRIPTION OF THE PREFERRED EMBODIMENTS

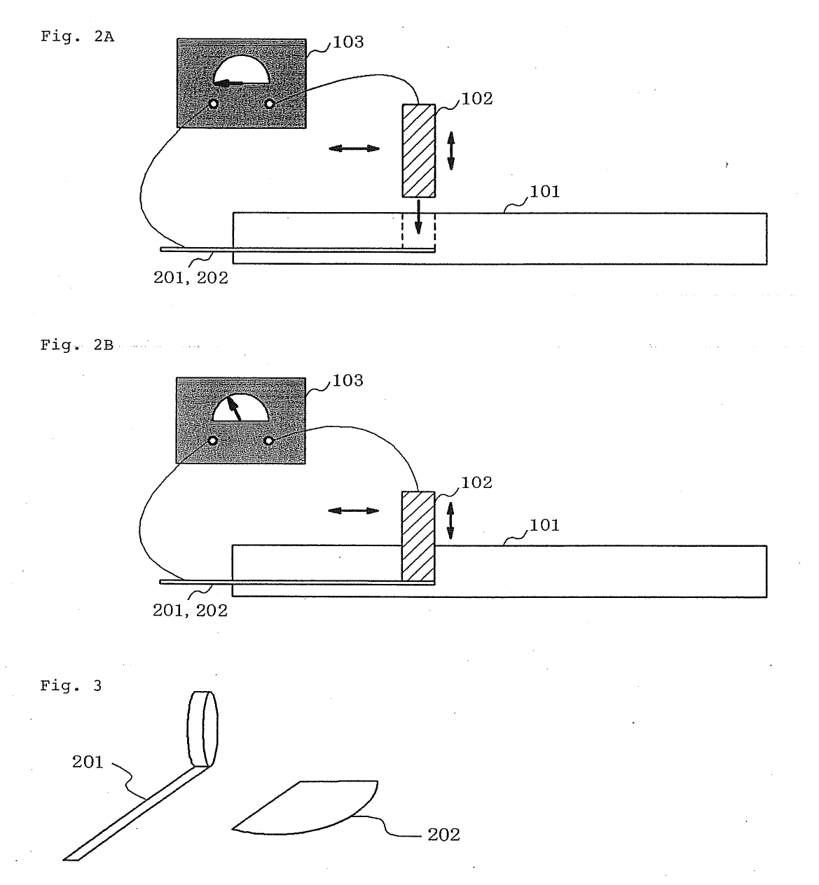

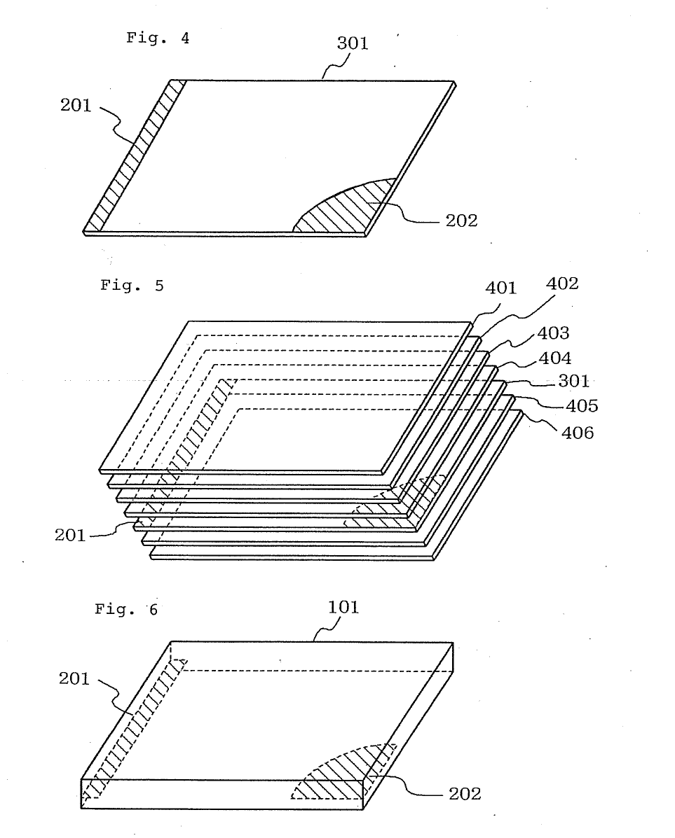

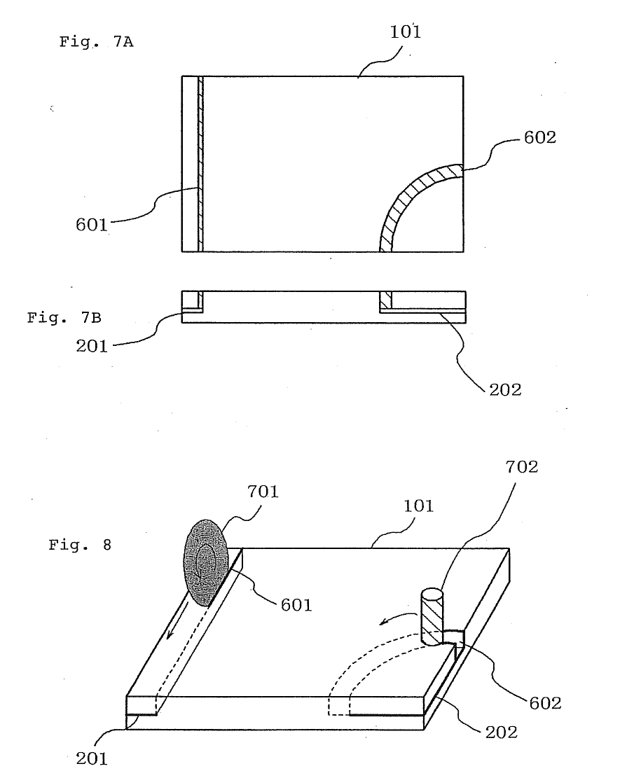

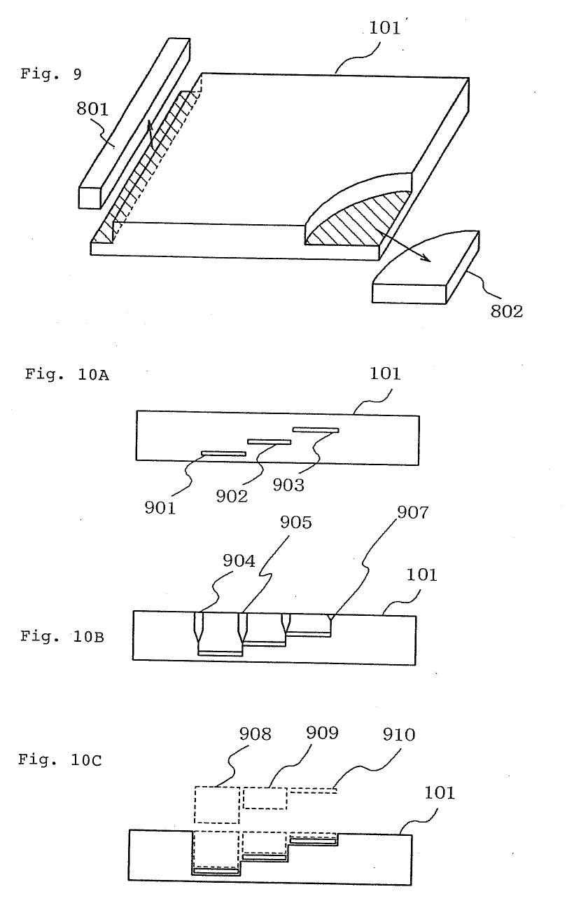

Hereinafter, an exemplary embodiment of a recess formation method according to the present invention will be described in details with reference to the drawings. FIGS. 2A and 2B are side views indicating the exemplary embodiment. FIG. 3 is a perspective view of release sheets used in the exemplary embodiment. FIG. 4 is a perspective view of a printed wiring board core material to which release sheets are attached. FIG. 5 is a perspective view indicating a laminated state of a core material to which release sheets are attached, and other layers. FIG. 6 is a perspective view of a multi-layer printed wiring board in which a layer to which release sheets are attached is internally disposed, that is, embedded. FIGS. 7A and 7B are plain and side views of a printed wiring board in which grooves have been formed using cutting tools. FIG. 8 is a perspective view indicating a groove formation method using V-cutting and routing. FIG. 9 is a perspective view of a printed wiring board in which portions where recesses are to be formed have been removed.

First, a release sheet used in a recess formation processing according to this exemplary embodiment will be described. For a material for the release sheet, a material that does not fuse with the printed wiring board material (epoxy, etc.) and resists the heat and pressure during laminating press. Examples of the material include polytetrafluoroethylene. Also, one surface of the release sheet may be made of an adhesive seal in order to prevent displacements during the laminating press of the printed wiring board.

Next, a procedure for recess formation processing according to the present exemplary embodiment will be explained. First, tape-like release sheet 201 having a shape identical to the shape of a recess to be formed, and release sheet 202 cut into a shape identical to the shape of a recess to be formed, are prepared. FIG. 3 shows an example of release sheets 201 and 202. Next, release sheets 201 and 202 are attached to core material 301 which will be an inner layer of the printed wiring board as shown in FIG. 4.

Then, as in an ordinary multi-layer printed wiring board manufacturing method, core material 301 and other inner layer materials (core material, prepreg material, etc.) 401, 402, 403, 404, 405 and 406 are laminated with one another as shown in FIG. 5. Thereafter, laminating press is performed, and the same manufacturing process as that for an ordinary multi-layer substrate, such as outer-layer circuit formation and resist formation, is performed, thereby printed wiring board 101 before recess formation processing is executed, can be obtained as shown in FIG. 6. Release sheets 201 and 202 are embedded in printed wiring board 101. As described above, printed wiring board 101 in which release sheets 201 and 202 are embedded is formed.

As shown in FIG. 7A and 7B, grooves 601 and 602 are formed by means of V-cutting or routing to the depth of the positions of release sheets 201 and 202 in printed wiring board 101 in which release sheets 201 and 202 are embedded. FIG. 7A is a plain view of printed wiring board 101, and FIG. 7B is a side view of printed wiring board 101.

A method for forming grooves 601 and 602 using V-cutting and routing, is shown in FIG. 8. The “V-cutting” is a processing method in which round cutter 701 having a blade formed along its outer periphery is rotated and V-letter shape groove 601 is formed by means of this cutter 701. The “routing” is a processing method in which end mill 702 having a helical cutting blade is moved while being rotated and groove 602 is formed by means of this end mill 702.

Then, lastly, as shown in FIG. 9, portions where recesses 801 and 802 are to be formed, are peeled off and are removed from printed wiring board 101, thereby the recess formation processing is completed.

Here, a method for forming grooves 601 and 602, which is a characteristic of the present invention, is described. In this exemplary embodiment, the electric resistance of release sheets 201 and 202 is measured to control the depth of grooves 601 and 602. Accordingly, the electric resistance of the surfaces of release sheets 201 and 202 on the side where grooves are to be formed is made to be lower than that of the material of the printed wiring board. For example, when release sheets 201 and 202 have an insulating property, a conductive coating material may be applied to the surfaces of release sheets 201 and 202 on the side where grooves are to be formed. Alternatively, since an insulating material is ordinarily used for the material for a printed wiring board, release sheets 201 and 202 themselves may be formed using a conductive material.

Then, as shown in FIGS. 2A and 2B, the electric resistance between release sheets 201 and 202 embedded in printed wiring board 101, and cutting tool 102 is measured using tester 103. FIG. 2A shows a state in which cutting tool 102 is not in contact with release sheets 201 and 202. Then, as shown in FIG. 2B, cutting tool 102 that comes into contact with release sheets 201 and 202 is detected by confirming that the electric resistance has turned to a finite value. As a result, it is possible to accurately form grooves having a depth equal to the depth of the release sheets. For cutting tool 102, either cutter 701 or end mill 702 shown in FIG. 8, may be used.

If cutting tool 102 has no conductivity, a contact bar made of a conductive material (not shown) may be disposed in the vicinity of the cutting tool to measure the electric resistance between the contact bar and the release sheets.

Also, in FIGS. 2A and 2B, release sheets 201 and 202 extend to the outside of printed wiring board 101. Such as when a recess that is not in contact with the outer periphery of printed wiring board 101 is formed, and such as when a release sheet cannot extend to the outer periphery of the printed wiring board, two contact bars may be disposed in the vicinity of the cutting tool to measure the electric resistance between the two contact bars.

In this exemplary embodiment, since the processing target for forming a recess, is a printed wiring board, the material constituting the processing target includes a plurality of layers. However, the material of the processing target including a plurality of layers is not an essential condition. For example, the present invention may also be applied in a similar manner also to a material in which a sheet is embedded as a result of integrally forming the sheet and a resin material.

### Advantageous Effect of the Exemplary Embodiment

As described above, in the recess formation method according to the present exemplary embodiment, a release sheet is embedded in an inner layer at a position of a printed wiring board where recess formation processing is performed. Then, using the fact that the conductive properties of the release sheet and the printed wiring board are different from each other, the release sheet and the cutting tool that come into contact with each other are detected, thereby forming a groove having a depth equal to the depth of the position where the release sheet is disposed.

Accordingly, in the present exemplary embodiment, it is possible to form, with high accuracy, a groove having a depth equal to the depth of the position where the release sheet is disposed, and also to remove, with high accuracy, a portion where a recess is to be formed alone. Accordingly, this exemplary embodiment has the advantageous effect of substantially reducing variations that occurred in the processing in the direction of the depth of the recess to be formed.

### FIRST EXAMPLE

A recess whose depth varies in a step-like manner can be formed using the recess formation method according to the present exemplary embodiment. In FIGS. 10A, 10B and 10C are side views that a forming method according to a first example, by which a recess whose depth varies in a step-like manner is formed. In this example, a recess having three levels of depth is formed.

In order to form such a recess, first, release sheets 901, 902 and 903 are embedded in different layers inside printed wiring board 101 (FIG. 10A). Then, grooves 904, 905, 906 and 907 are formed using the same method as in FIG. 8. At this time, the depths of grooves 904, 905, 906 and 907 are controlled using the method shown in FIGS. 2A and 2B. Then, portions where recess 908, 909 and 910 are to be formed, are removed (FIG. 10C). The details of this processing will be omitted since they are the same as in the above-described exemplary embodiment.

As a matter of course, it is not necessary that the figures (sizes and shapes) of release sheets 901, 902 and 903 be identical to each other.

### ADVANTAGEOUS EFFECT OF FIRST EXAMPLE

As described above, according to the first example, release sheets are attached to different layers inside printed wiring board 101, and recesses having different depths are sequentially formed using the release sheets disposed on the respective layers.

Therefore, the first example has the advantageous effect of being capable of easily forming a recess whose depth varies in a step-like manner.

### SECOND EXAMPLE

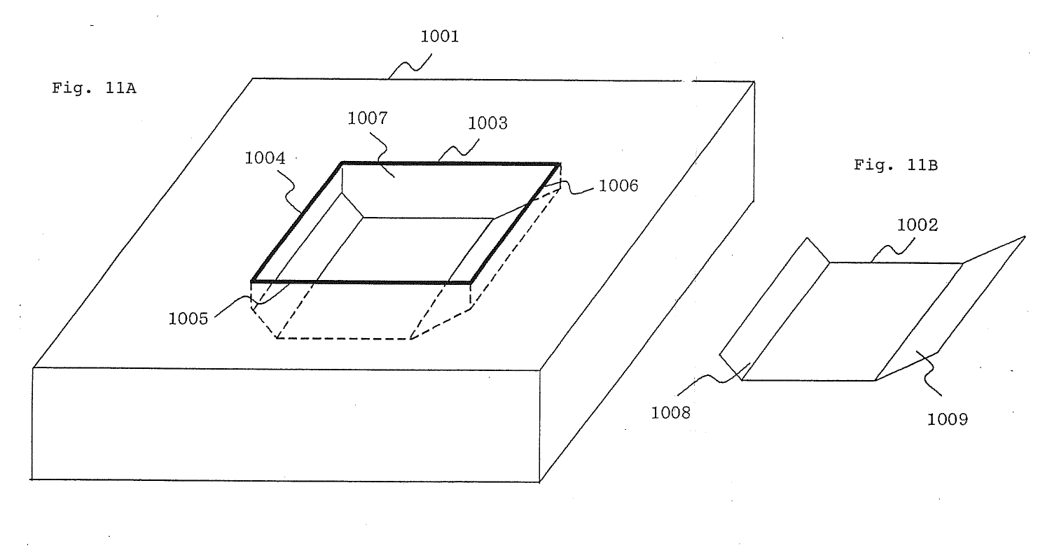

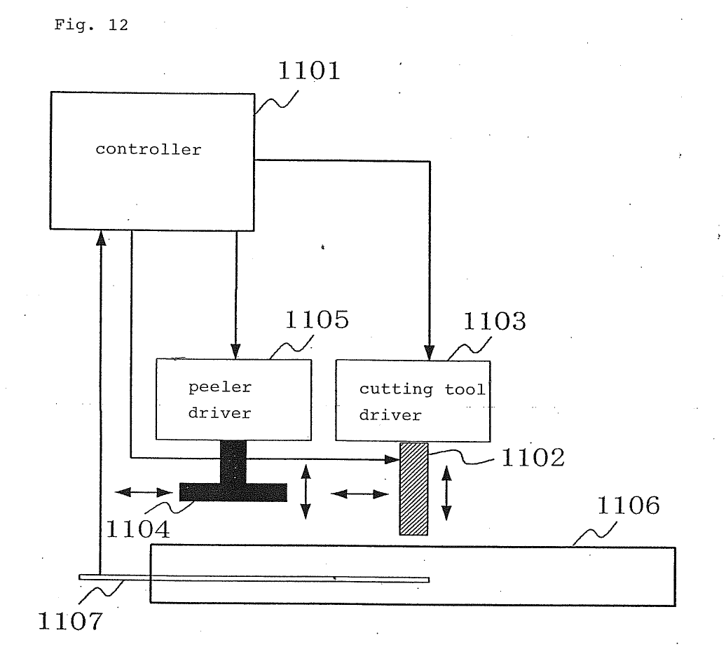

A recess whose depth varies in an inclined or curved manner can be formed using the recess formation method according to the present exemplary embodiment. FIGS. 11A and 11B show perspective views of a printed wiring board according to a second example, in which a recess whose depth varying in an inclined manner is formed. In this example, a recess is formed in a shape having a bottom surface, side surfaces and inclined surfaces that connect the bottom surfaces and the side surfaces.

In order to form a recess having such shape, first, release sheet 1002 having a shape shown in FIG. 11B is embedded in material 1001, which is the recess formation object. This release sheet 1002 has inclined surfaces for forming inclined surfaces in the recess. Then, using the routing shown in FIG. 8, a groove is formed along sides 1003, 1004, 1005 and 1006 of material 1001. At this time, the necessary groove depth is not constant, so the depth of the groove is controlled using the method shown in FIGS. 2A and 2B.

After the groove is formed along all of sides 1003, 1004, 1005 and 1006, a portion where the recess 1007 is to be formed, is removed. The details of this processing will be omitted since they are similar to those of the exemplary embodiment and the first example.

Although the recess formed according to this example has inclined surfaces 1008 and 1009, which each constitute a flat surface, a recess having curved surfaces can also be formed instead of these inclined surfaces.

### ADVANTAGEOUS EFFECT OF SECOND EXAMPLE

As described above, the second example makes it possible to form a recess whose internal depth varies by embedding a release sheet that has inclined or curved surfaces in a material targeted for processing, and by forming a groove in the depth where the release sheet is disposed while detecting the electric property of the release sheet.

Accordingly, this example has the advantageous effect of easily forming a recess even if there are inclined or curved surfaces in the inside of the recess.

### THIRD EXAMPLE

An example of a configuration of a recess formation device for carrying out the recess formation method according to the present exemplary embodiment is shown. FIG. 12 is a block diagram illustrating a configuration of a recess formation device according to a third example.

The recess formation device includes controller 1101, cutting tool 1102, cutting tool driver 1103, recess peeler 1104, and peeler driver 1105. Cutting tool driver 1103 controls the position of cutting tool 1102 in a vertical direction and a horizontal direction that is substantially parallel to the material surface using a motor, etc. Recess peeler 1104 sucks and thereby removes the portion, where a recess is to be formed, and this portion being peeled off from material 1106 of the recess formation target. Peeler driver 1105 controls the positions of the vertical and horizontal directions of recess peeler 1104, and also controls the sucking and releasing performed by recess peeler 1104.

Controller 1101 measures the electric resistance between material 1106 and release sheet 1107. For that purpose, a voltage is applied to cutting tool 1102 to measure the current value between cutting tool 1102 and release sheet 1107. Then, until the electric resistance that changes from electric resistance R2 for material 1106 to electric resistance R1 for release sheet 1107 is detected, controller 1101 controls cutting tool driver 1103 to let down cutting tool 1102.

After that, while confirming the electric resistance, controller 1101 makes cutting tool 1102 move horizontally along the outer periphery of release sheet 1107. In order to move cutting tool 1102 horizontally along the outer periphery of release sheet 1107, the position of cutting tool 1102 may be numerically controlled based on the shape of release sheet 1107. Alternatively, the outer periphery (outer shape) of release sheet 1107 can be confirmed by detecting variation in the electric resistance between R1 and R2.

In the above-described exemplary embodiment, and in the first, second and third examples, contact between cutting tool 1102 and release sheet 1107 is detected by measuring the electric resistance between material 1106 and release sheet 1107. However, the method for detecting the contact between cutting tool 1102 and release sheet 1107 is not limited to methods employing electric resistance, and the difference in another physical property between cutting tool 1102 and release sheet 1107 may also be used.

Examples thereof include a method that uses the difference in elastic modulus between material 1106 and release sheet 1107. In other words, the contact can be detected by measuring the magnitude of the force required to lower cutting tool 1102 in the downward direction, using release sheet 1107, which is soft (i.e., have smaller elastic modulus [Young's modulus]) relative to material 1106.

### ADVANTAGEOUS EFFECT OF THE THIRD EXAMPLE

As described above, a recess can be formed by automatically forming a groove in a material in which a release sheet is embedded while detecting the electronic property and peeling off an unnecessary portion, using the recess formation device according to the third example.

Accordingly, the third example has the advantageous effect of being capable of easily forming a recess having a desired depth with high accuracy.

While the invention has been shown and described with particular reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A recess formation method comprising:
forming a material with a sheet disposed therein, the sheet having a planar shape identical to a planar shape of a recess to be formed and having a first physical property, the material having a second physical property that is different from the first physical property;
cutting the material in a depth direction that is a direction going from a first surface of the material toward a second surface of the material facing the first surface, using a predetermined cutting tool;
detecting a third physical property that is a physical property of a deepest part of the cut portion, using a predetermined detector;
terminating the cutting in the depth direction when the third physical property is equal to the first physical property;
cutting the material in a horizontal direction that is substantially parallel to the first surface to form a groove, thereby dividing the first surface into a first region having a shape identical to the planar shape, and into a second region which is not included in the first region; and
peeling off the material between the sheet and the first surface in the first region.

2. The recess formation method according to claim 1, wherein:
the material includes a plurality of layers, the plurality of layers including a first layer and a second layer positioned below the first layer viewed from the first surface, and the sheet is embedded between the first layer and the second layer; and
the method further comprising peeling off the material above the second layer viewed from the first surface in the first region, from the sheet.

3. The recess formation method according to claim 1, wherein the physical property of the material corresponds to the electric conductivity of the material.

4. The recess formation method according to claim 1, wherein the physical property of the material corresponds to the elastic modulus of the material.

5. The recess formation method according to claim 1, wherein the sheet includes a surface coated with a coating material having the first physical property.

6. A cutting device for forming a recess in a material, the cutting device comprising:
a cutter that cuts a material with a sheet disposed therein in a depth direction that is a direction going from a first surface of the material toward a second surface of the material facing the first surface, the sheet having a planar shape identical to a planar shape of a recess to be formed and having a first physical property, the material having a second physical property that is different from the first physical property;
a detector that detects a third physical property that is a physical property of a deepest part of the cut portion;
a controller that terminates the cutting in the depth direction when the third physical property is equal to the first physical property, and that cuts the material in a horizontal direction that is substantially parallel to the first surface to form a groove, thereby dividing the first surface into a first region having a shape identical to the planar shape, and into a second region that is the other region; and
a peeler that peels off the material between the sheet and the first surface in the first region.

7. The cutting device according to claim 6, wherein:
the material includes a plurality of layers, the plurality of layers including a first layer and a second layer positioned below the first layer viewed from the first surface, and the sheet is embedded between the first layer and the second layer; and
the peeler peels off the material above the second layer viewed from the first surface in the first region, from the sheet.

8. The cutting device according to claim 6, wherein the physical property is the electric conductivity of the material.

9. The cutting device according to claim 6, wherein the physical property is the elastic modulus of the material.

10. The cutting device according to claim 6, wherein the sheet includes a surface coated with a coating material having the first physical property.

11. A formation material for a recess comprising:
a sheet having a planar shape identical to a planar shape of a recess to be formed and having a first physical property; and
a second physical property that is different from the first physical property,
wherein the recess being formed includes:
cutting the material in a depth direction that is a direction going from a first surface toward a second surface facing the first surface, using a predetermined cutting tool;
detecting a third physical property that is a physical property of a deepest part of the cut portion, using a predetermined detector;
terminating the cutting in the depth direction when the third physical property is equal to the first physical property;
cutting the material in a horizontal direction that is substantially parallel to the first surface to form a groove, thereby dividing the first surface into a first region having a shape identical to the planar shape, and a second region that is the other region; and
peeling off a portion between the sheet and the first surface in the first region.

12. The formation material for a recess according to claim 11, wherein:
the formation material for the recess includes a plurality of layers, the plurality of layers including a first layer and a second layer positioned below the first layer viewed from the first surface, and the sheet is embedded in the first layer and the second layer; and
the recess is formed by peeling off the formation material for the recess in the first region from the sheet.

13. The formation material for a recess according to claim 11, wherein the physical property of the material corresponds to the electric conductivity of the formation material for recess.

14. The formation material for a recess according to claim 11, wherein the physical property of the material corresponds to the elastic modulus of the formation material for recess.

15. The formation material for a recess according to claim 11, wherein the sheet includes a surface coated with a coating material having the first physical property.
